(19) United States
(12) Patent Application Publication
(10) Pub. No.: US 2026/0234840 A1
(43) Pub. Date: Aug. 13, 2026

(54) ACTIVE TEXTILES

(71) Applicant: PLECTRUM LTD., Modi'in-Maccabim-Re'ut (IL)

(72) Inventors: Gabriel LEV-HAR, Modi'in-Maccabim-Re'ut (IL); Israel Oz DANIEL, Meitar (IL)

(21) Appl. No.: 19/150,156

(22) PCT Filed: Jan. 24, 2024
(86) PCT No.: PCT/IL2024/050097

§ 371 Date: Jul. 22, 2025

(30) Foreign Application Priority Data
Jan. 24, 2023 (IL) 300156

(51) Int. Cl. D02G 3/44; B06B 1/04; D03D 1/00; D03D 15/533; G06F 1/16

(52) U.S. Cl. CPC D02G 3/441; B06B 1/045; D03D 1/0088; D03D 15/533; G06F 1/163; G06F 1/1698; D10B 2401/16; D10B 2501/00

(57) ABSTRACT

An active textile comprising a weave comprised of threads made of a plurality of conductive fibers; a plurality of magnets; and a plurality of non-conductive, non-magnetic flexible fabric fibers; a controller for generating and selectively transmitting electric current along the conductive fibers and a power source. Selective transmittal of electric current along the conductive fibers selectively induces magnetic fields that operate on the magnets, thereby producing physical movements within the textile.

### FIELD OF THE INVENTION

The present Application relates to the field of smart textiles, and more specifically, but not exclusively, to an active textile that is capable of delivering a touch sensation in continuous vectors across both the extent and depth of a garment.

### BACKGROUND OF THE INVENTION

Technologically-enhanced clothing has practical applications in diverse fields such as medicine, sports, and gaming. In the field of medicine, a piece of clothing may include electrodes for stimulating body muscles. In sports, fitness clothing may include sensors that may be used to monitor a player's running or ball-playing technique. With respect to gaming, “smart” clothing may deliver a haptic sensation that indicates events of the game.

To date, most wearable technological devices are standalone electronic devices. Examples include fitness trackers, heart rate monitors, and augmented reality glasses. Such products have exploded in popularity in recent years. By contrast, products that integrate electronics into textiles, and in particular those that generate sensations of movements in electronic textiles (hereinafter “active textiles”) have achieved significantly less market presence.

This limited adoption of active textiles may be attributed to various limitations of presently available technology. First, integration between the textile components and the electronic components may be limited. In most currently available implementations, the electronic components effectively function only as standalone units within the textiles. Relatedly, the electronic components are unable to supply a sensation at every point in the textile, and instead are only able to deliver a haptic sensation at specified locations. This limits the extent of the sensation that may be experienced by the user. Other challenges of presently available electronic textiles include the high voltage that these devices typically carry, and the discomfort associated with the electronic wiring.

### SUMMARY OF THE INVENTION

The present disclosure improves upon existing active textiles by introducing active textiles that are capable of delivering a holistic sensory experience throughout the entire garment. An active textile is comprised of a weave of electronic and magnetic fibers within a standard textile fiber. The weave provides a similar level of comfort to the standard textile fiber. Selective application of an electric field to the electric fibers induces micro-magnetic fields, which cause the magnetic fibers to vibrate or move towards or against the body. The vibration of the magnetic fibers is not limited to specific zones but may be sensed as traveling up and down the fabric of the textile, in continuous vectors. In addition, the vibration of the magnetic fibers may convey a push-and-pull sensation along the depth of the garment.

The active textiles of the present disclosure may be used for various applications, including health, business, and gaming. In the gaming implementation, the active textiles according to the present disclosure enable the transfer of a sensation from a virtual world to reality. The fibers of the active textile convey a continuous and adaptive sense of touch during playing of a game.

According to a first aspect, an active textile is disclosed. The active textile includes: a weave comprised of threads made of a plurality of conductive fibers; a plurality of magnets; and a plurality of non-conductive, non-magnetic flexible fabric fibers; a controller for generating and selectively transmitting electric current along the conductive fibers; and a power source. Selective transmittal of electric current along the conductive fibers selectively induces magnetic fields that operate on the magnets, thereby producing physical movements within the textile.

In another implementation according to the first aspect, the induced physical movements are vibrations of varying intensities.

In another implementation according to the first aspect, the control circuit includes a transceiver for wirelessly receiving commands to selectively transmit the electrical pulses.

In another implementation according to the first aspect, each conductive fiber includes an inner conductive core and an insulating sheath surrounding the conductive core.

In another implementation according to the first aspect, the conductive material is configured to conduct a current of up to approximately 200 milliamps.

In another implementation according to the first aspect, the magnets are embedded in capsules, wherein the capsules are oriented along a length of fibers that are parallel to the conductive fibers.

In another implementation according to the first aspect, the plurality of conductive fibers comprise hollow conductive fibers, said hollow conductive fibers comprising an interior cavity, one or more magnets within the interior cavity, and a conductive wire coiled around the interior cavity, wherein transmittal of an electric pulse on the conductive wire generates a magnetic field within the interior cavity, causing movement within the cavity of the one or more magnets. Optionally, a ferromagnetic material is included within the interior cavity.

In another implementation according to the first aspect, the weave comprises a three-dimensional structure with a plurality of layers, wherein the conductive fibers are spaced at minimum distances from each other both horizontally, within each layer, and vertically, between different layers. Optionally, a magnetic insulator is included in between one or more of the layers.

Optionally, selective transmittal of electric current among different vertical layers creates a push-and-pull sensation along a depth of the active textile. Optionally, selective transmittal of electric current along an extent of a conductive fiber within a particular layer generates a touch sensation along an extent of the active textile in a continuous vector.

In another implementation according to the first aspect, a garment includes the active textile.

In another implementation according to the first aspect, a system includes the active textile of claim 1; a display; and a computer program product comprising software instructions that, when executed by the computer, cause (1) display of a scene on the display; and (2) issuing of instructions from the control circuit to generate physical movements of the active textile that are consistent with the scene.

According to a second aspect, a method of controlling movement of an active textile is disclosed. The method includes: selectively transmitting electric current along conductive fibers of an active textile, wherein the active textile includes a weave comprised of threads made of a plurality of conductive fibers; a plurality of magnets; and a plurality of non-conductive, non-magnetic flexible fabric fibers; a control circuit for generating and selectively transmitting electric current along the conductive fibers; and a power source. Selective transmittal of electric current along the conductive fibers selectively induces magnetic fields that operate on the magnets, thereby producing physical movements within the textile.

In another implementation according to the second aspect, the physical movements comprise vibrations of varying intensities.

In another implementation according to the second aspect, the physical movements comprise movement along the length of a fiber caused by travel of a magnet within said fiber.

In another implementation according to the second aspect, the method further includes selectively transmitting electric current among different vertical layers to thereby create a push-and-pull sensation along a depth of the active textile.

In another implementation according to the second aspect, the method further includes selectively transmitting electric current along an extent of a conductive fiber within a particular layer to thereby generate a touch sensation along an extent of the active textile in a continuous vector.

In another implementation according to the second aspect, the method further includes displaying a scene on a display, and generating physical movements of the active textile that are consistent with the scene.

### BRIEF DESCRIPTION OF THE DRAWINGS

FIG. 1 illustrates a system for controlling an active textile, according to embodiments of the present disclosure;

FIG. 2 is a perspective view of a woven fiber of an active textile, according to embodiments of the present disclosure;

FIG. 3 is a cross-section view of a woven fiber of an active textile, according to embodiments of the present disclosure;

FIG. 4 is a perspective view of a multilayer active textile including a layer with magnets contained in pods, according to embodiments of the present disclosure;

FIG. 5 is a perspective view of an active textile including an integrated electric and magnetic fiber, according to embodiments of the present disclosure;

FIG. 6 is an illustration of a magnetic field generated in the integrated electric and magnetic fiber of FIG. 5, according to embodiments of the present disclosure.

FIG. 7 illustrates one possible configuration of a multilayer active textile, according to embodiments of the present disclosure;

FIG. 8 schematically illustrates operation of the active textile, according to embodiments of the present disclosure;

FIG. 8a schematically illustrates operation of the active textile, according to embodiments of the present disclosure, when current of the same magnitude but of opposite polarity as the current supplied in FIG. 8 is supplied to conductive fibers;

FIG. 9 illustrates an exemplary implementation of the active textile, illustrating a garment with haptic zones, according to embodiments of the present disclosure;

FIG. 10 is an exemplary diagram showing electrical control of the active zones of the garment of FIG. 9, according to embodiments of the present disclosure;

FIG. 11 illustrates a gaming implementation for the active textiles, according to embodiments of the present disclosure;

FIGS. 12a-f illustrate six weaves, respectively, of selectively positioned coiled fibers used for producing a textile-generated and electrically stimulated sensation;

FIGS. 13a-f illustrate six different types of magnetic fibers, respectively, for use in an active textile;

FIGS. 14a-c illustrate three different types of ferromagnetic fibers, respectively, for use in an active textile;

FIGS. 15a-b illustrate two capsule-based fiber arrangements, respectively;

FIGS. 16a-b schematically illustrate two sensations, respectively, felt by a wearer of an active textile garment;

FIG. 17 illustrates a method for generating a sensation with an active textile garment;

FIG. 18 is a schematic illustration of a fiber within a lumen of which control circuitry for operating active textile is positioned; and

FIGS. 19-20 illustrate two possible implementations of voltage supply and command to capsules and coils, according to embodiments of the invention.

### DETAILED DESCRIPTION OF THE INVENTION

The present Application relates to the field of smart textiles, and more specifically, but not exclusively, to an active textile that is capable of delivering a touch sensation in continuous vectors across both the extent and depth of a garment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

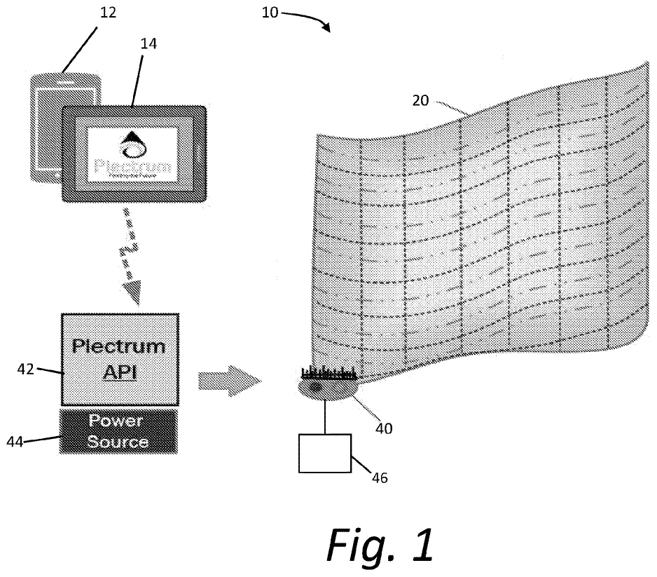

FIG. 1 schematically illustrates components of a system 10 for operation of an active textile 20. System 10 includes a computer program product that is stored on a memory of device 12 and operated by a processor of device 12. The memory is a non-transitory computer-readable medium containing instructions that, when executed by the processor, cause the processor to execute particular steps, as described further herein. Device 12 may be any suitable device for operating the computer program product, including a mobile phone, tablet computer, personal computer, medical device, or gaming system. Device 12 may be a physically integrated computer, a cloud-based computer, and/or a virtualized computer. Device 12 may include display 14. The display 14 may display images and/or video to a user. For example, in the gaming context, the display may include images representing the perspective of the player in an imaginary scene. Although not illustrated here, the system may further include additional sensory devices, such as earphones or earbuds, augmented reality glasses, or virtual reality glasses.

System 10 further includes active textile 20. The active textile 20 contains electric and magnetic fibers that enable transmission of a movement across the extent of the textile. Although illustrated here as a polygonal fabric, the active textile may be shaped as an article of clothing.

Active textile 20 includes a controller 40. The controller 40 may include a power source 44. The power source may be a rechargeable battery, such as a lithium ion battery, or a disposable battery. The power source may also be a wireless power source, such as based on infrared rays or RF transmission. The controller 40 further includes a wireless receiver or transceiver 46 for receiving commands from device 12 (for example, via Bluetooth, Bluetooth Low Energy, or Wi-Fi protocols). An application programming interface (API) 42 translates the received commands and implements them to particular fibers on the active textile. Specifically, the controller 40 generates and selectively transmits electrical pulses along the conductive fibers of the textile 20, as will be described further herein. Controller 40 also may include an on-off switch for enabling or disabling function of the active textile 20.

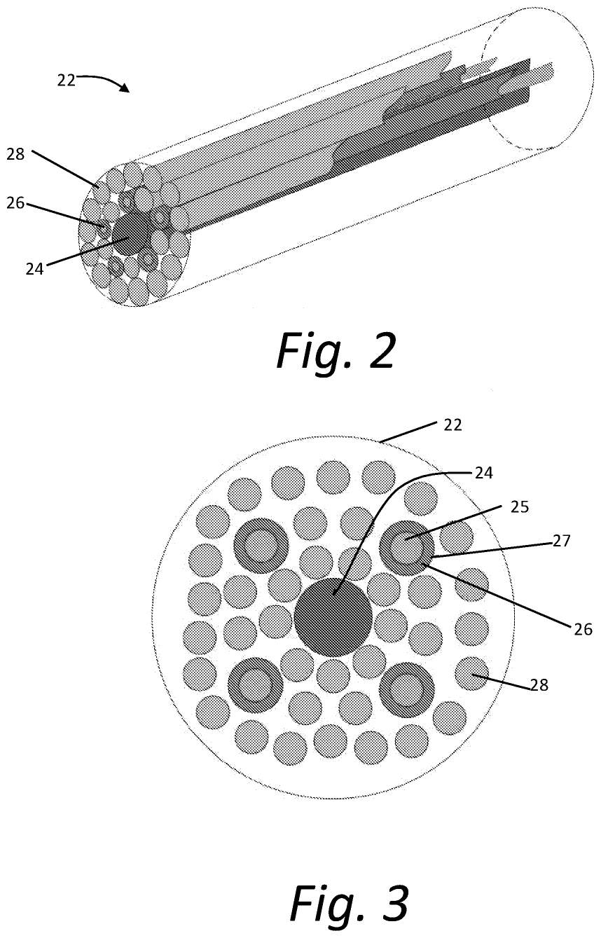

FIGS. 2 and 3 illustrate the composition of active textile 20, according to embodiments of the present disclosure. In general, the active textile is made of a washable fabric, and contains electronic and magnetic capabilities that allow physical movement of the fabric along its length and width when receiving wireless command. The fabric is flexible, stretchy, and washable without ironing.

The active textile 20 is a weave comprised of threads woven from a plurality of fibers or yarns 22. Each fiber 22 includes a flexible base nano-fiber 24. The base nano-fiber may be selected for qualities of strength and flexibility, and need not be comfortable to the touch. Each base nano-fiber 24 is surrounded by two other types of fibers: a conventional nano-fiber 28, and a conductive integrated nanofiber 26. The conventional nano-fiber is non-conductive and non-magnetic and is flexible, and it may be made of any suitable material meeting these criteria. In exemplary embodiments, the conventional nano-fiber 28 is made of an electro-spun organic polymer. Preferably, the entire external surface of the fiber 22 is made of the conventional nano-fiber 28, thus ensuring maximum comfort for the wearer.

The conductive integrated nanofiber 26 includes an inner conductive core 25 made of conductive material (e.g., copper, or a conductive polymer) and an insulating sheath 27 (e.g., a plastic or polymer). The conductive material is configured to carry up a current of up to approximately 200 milliamperes (mA). This current is sufficient for implementing the functions described herein, while also being sufficiently limited to ensure that the wearer is protected in the event of an accidental cut or short in the wiring.

The number of the conductive fibers 26 within the fibers 22 may vary. Thus, in FIG. 2, there are five conductive fibers, while in FIG. 3, there are four conductive fibers. That said, the placement of the conductive fibers directly influences the magnetic field generated by each of the fibers, and the resulting haptic effects, as will be discussed further herein. Thus, typically, there is a separation between respective conductive fibers 26, in all directions, in order for each conductive fiber to exert an independent influence on the micro-magnets in the active textile.

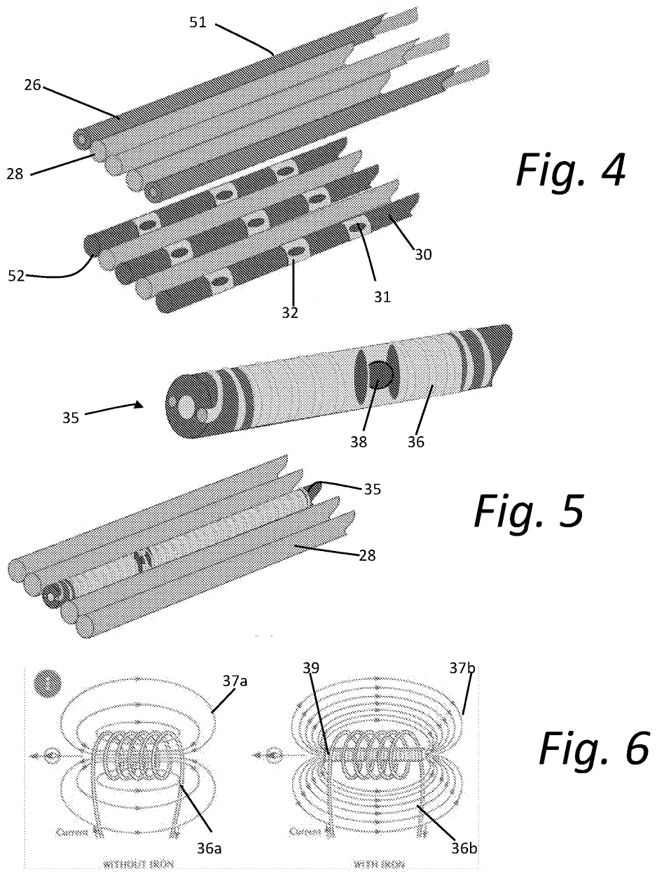

Referring now to FIGS. 4-6, the touch sensation is generated by movement of micro-magnets within the active textile.

FIG. 4 illustrates a capsule-style embodiment of a magnetic fiber. In this embodiment, the micro-magnets are external to the conductive fibers. The active textile of FIG. 4 includes a first layer 51 containing conductive fibers 26, and a second layer 52. The second layer 52 includes fibers 30 having magnets 31 within capsules 32. The magnets 31 within the capsules 32 are oriented parallel to the conductive fibers 26. When a current is drawn through the conductive fibers 26, a circumferential magnetic field is generated around the conductive fiber. The direction of the magnetic field is determined by the direction of flow of current, according the “right-hand rule.” The strength of the magnetic field is determined by the intensity of the current, as is known to those of skill in the art, and in accordance with Faraday's law and Lenz's law. When the magnetic field reaches the magnets 31 within capsules 32, the magnets orient themselves to align with the magnetic field. Selective control of the current in different conductive fibers 26 within the active textile causes the magnetic field to be manifested at different locations within the magnetic fiber, and correspondingly generates the sensation that the touch effect is moving along the length of the fibers. Although each magnet is located at a discrete point along the magnetic fiber, if the magnets are distributed with sufficient density along the magnetic fiber, this effect may be perceived to be continuous.

FIG. 5 illustrates a coil-style embodiment of a magnetic fiber. In this embodiment, conductive fiber 35 is hollow. The hollow conductive fibers 35 include an interior cavity, one or more magnets 38 within the interior cavity. A conductive wire 36 is coiled around the interior cavity. As is known to those of skill in the art, running a current through the coiled conductive wire 36 causes a magnetic field to be generated within the cavity. This magnetic field is oriented along the same axis as the hollow conductive fiber, with the direction of the field determined by the direction of the current, and the strength of the field determined by the strength of the current. The induced magnetic field causes the micro-magnet 38 to travel along the entire length of the cavity. Advantageously, the movement of the magnet 38 along the length of the field generates a sensation that travels across a garment.

FIG. 6 illustrates a potential variation on the embodiment of FIG. 5, in which a ferromagnetic material 39 is fixed within the interior cavity. In the embodiment to the left of FIG. 6, a current is drawn through coil 36a when there is no ferromagnetic material within the coil 36a, generating a resulting magnetic field 37a. In the embodiment of the right of FIG. 6, the same current is drawn through coil 36b, but a ferromagnetic material 39 is fixed within the coil. The resulting magnetic field 37b is significantly stronger. The inclusion of a fixed ferromagnetic material 39 within the cavity may thus enable fine-tuning of the strength of the induced magnetic field.

The active textile of the present disclosure may include both types of magnetic fibers, as desired. Each type of magnetic fiber may supply particular benefits. For example, the coil style magnetic fibers may be useful for gross sensations, while the the capsule style magnetic fibers may be useful finer-tuned sensations. In addition, the magnetic effect of the capsule style fibers may be more easily reversible than that of the coil style fibers. In addition, it may be desirable to have one type of fiber in a part of the garment that is worn closer to the body, and another type of fiber in a part of the garment that is further from the body.

It is to be noted that, as illustrated in FIG. 6, the current not only generates a strong magnetic field within the coil, but also generates a magnetic field outside the coil. This magnetic field outside the coil may influence the magnets of the capsule-style magnetic fibers, unless the capsule-style magnetic fibers are separated from the coil-style magnetic fibers with a magnetic insulator.

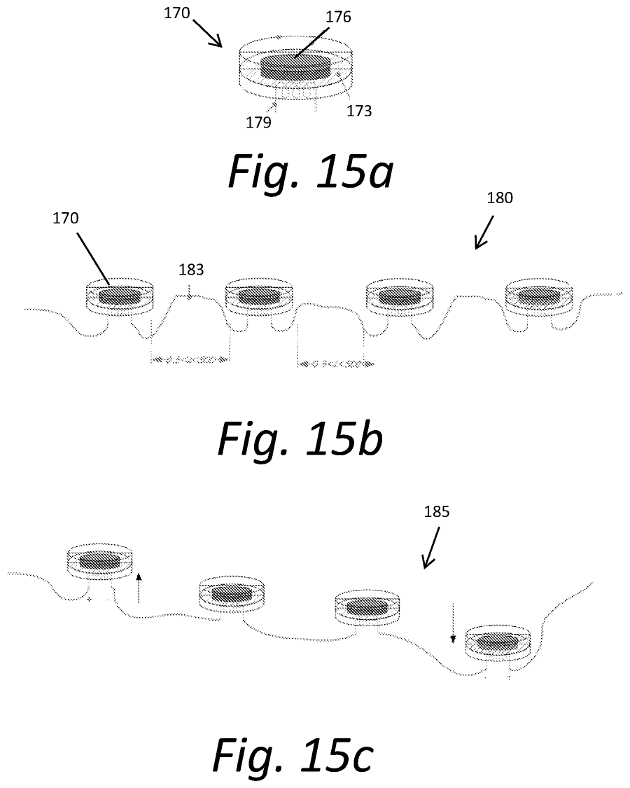

FIGS. 15a-c illustrates other embodiments of a capsule-style magnetic fiber.

FIG. 15a illustrates a capsule 170 which comprises a flexible metallic casing 173, a permanent magnet 176 and a coil 179. Permanent magnet 176 and coil 179 are positioned within the casing interior, while the two ends of coil 179 penetrate the casing and are connected to a conductive fiber.

FIG. 15b illustrates a capsule-connected fiber arrangement 180 whereby four capsules 170 each attached to two conductive fibers 183 are interspersed throughout a garment. When a coil is energized, the corresponding permanent magnet attracts the casing t to cause a change in the length of the entire fiber.

In the fiber arrangement 180 of FIG. 15c, each coil of the two intermediate capsules is de-energized while the coil of the other two capsules is energized with current of opposite polarity.

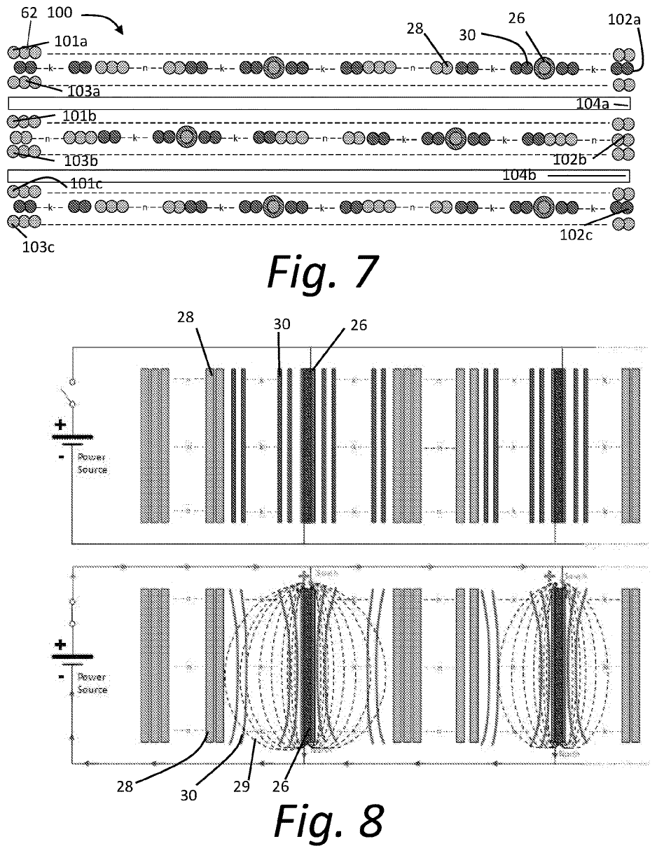

FIG. 7 illustrates a configuration of a multi-layered active textile 100 formed as a weave. Each layer of the multilayered textile 100 includes a “sandwich” consisting of three sub-layers 101, 102, 103. Sub-layers 101 and 103 are entirely made of fabric fibers 62. Sub-layer 102, in the middle of the sandwich, consists of a plurality of conductive fibers 26. The conductive fibers 26 are surrounded by a number “k” of magnetic fibers 30 adjacent to the conductive fibers 26, and a number “n” of fabric fibers 28 for spacing between the magnetic fibers. Thus, the conductive fibers are spaced at minimum distances from each other horizontally, within each layer. Fabric fibers 28 may be of the same material as fabric fibers 62. Alternatively, the fabric fibers 28 may be different from fabric fibers 62. As can be readily understood, fabric fibers 62 may be on the external face of the textile 100, and thus must have suitable characteristics with respect to comfort and breathability. By contrast, the fabric fibers 28 are not skin-contacting, and thus may, theoretically, be of a different material.

Between different layers, there may be an insulating layer 104. The insulating layer may be made of any suitable magnetic insulator, such as ferrite. The insulating layer may also be a yarn or polymer with magnetic insulating capabilities, such as cotton or polyester. The insulating layers serve to prevent the magnetic field that is generated by the conductive fibers of each layer from penetrating into an adjacent layer.

In addition, as can be seen, the conductive fibers from each layer are spaced horizontally compared to the conductive fibers of an adjacent layer. That is, conductive fibers 26 of layer 102a are laterally displaced with respect to those of layer 102b, which are displaced from those of layer 102c. Thus, respective conductive fibers are displaced a minimum distance from each other vertically, between different layers. This displacement works in conjunction with the insulation in order to isolate the effect of each conductive fiber on adjacent magnets.

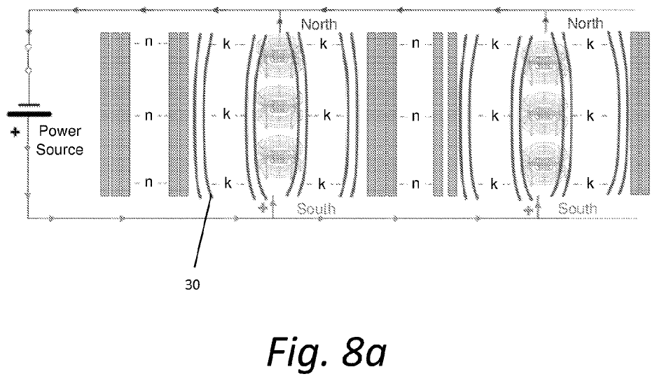

FIG. 8 illustrates the effect of inducing a magnetic field on the magnetic fibers. In the upper schematic of FIG. 8, conductive fiber 26 is surrounded by magnetic fibers 30, which are spaced by fabric fibers 28. No power is drawn through the circuit, and, as a result, no magnetic field is introduced. In the lower schematic, a current is drawn through the conductive fiber 26, from the top to the bottom of the Figure as shown. As a result, a magnetic field 29 is induced around the conductive fiber 26, with the southern pole being at the top of the Figure and the northern pole being at the bottom of the figure. As a result, the magnets in the magnetic fibers are drawn to the magnetic field surrounding conductive fiber 26, with the strongest attraction being felt by the magnetic fibers closest to the conductive fiber 26, and weaker attraction being felt by magnetic fibers that are further from the conductive fiber. If the current were reversed (i.e., traveling from the bottom to the top of the Figure), the poles of the magnetic field would likewise reverse, and the magnets would be repelled from, rather than attracted to, the conductive fiber 26. Each active textile may contain a suitable number of such conductive and magnetic fibers, through which the electric current may be controlled in order to cause a selective touch feeling at different points in the textile. When a current is applied and then quickly released, the effect of the movement of the magnetic fibers simulates a vibration. Depending on the strength of the current that is applied, the vibration may be felt in varying intensities. When the current is applied to different points in the garment that form a line, the vibration generates a sensation along the extent of the garment, in a continuous vector. In addition, when the current is applied at points having different depths at the same location on the garment, the sensation is perceived as a pushing and pulling in the depth vector of the garment.

FIG. 8a illustrates the effect of inducing a magnetic field on magnetic fibers 30 when current of the same magnitude but of opposite polarity as the current supplied in FIG. 8 is drawn through conductive fibers 26.

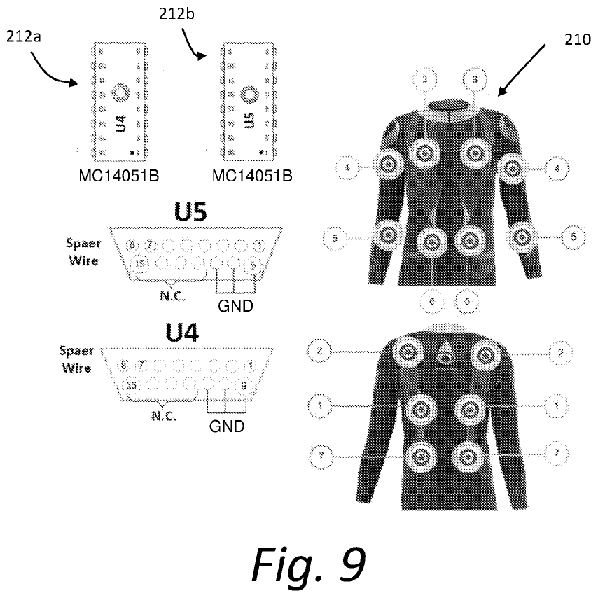

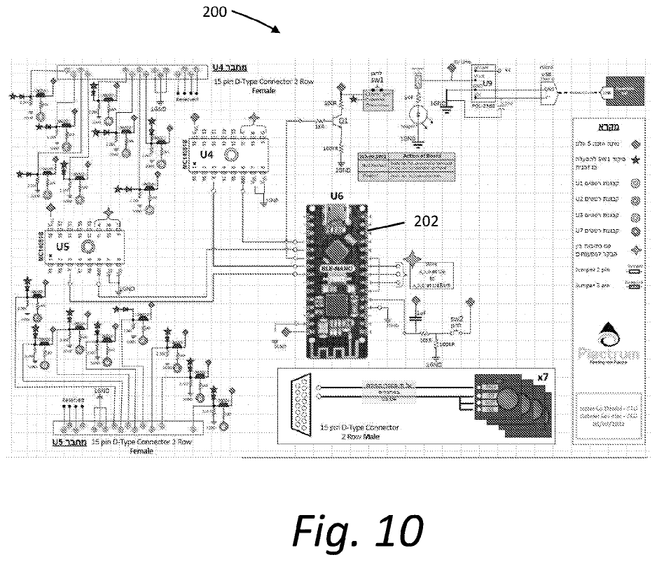

FIG. 9 illustrates a garment 210 made of the active textiles described herein. The garment includes 14 zones of touch activity-four on the chest, four on the back, two on the shoulders, two on the upper arms, and two on the lower arms. The zones of touch activity are controlled by multiplexers 212a and 212b. In the illustrated example, each multiplexer is a digitally-controlled analog switch. Each zone of touch activity is connected to a single pin on the multiplexer. Depending on the needs of the situation, certain of the pins may be “ground” or “normally closed” (N.C.). The multiplexer may be operated with any suitable switch, such as a SP8T solid state switch. FIG. 10 illustrates an exemplary block diagram 200 of a control circuit, showing control of the switches on the multiplexers from a printed circuit board 202.

In another embodiment, a garment made of active textiles need not be produced with distinct zones of touch activity, but rather the touch activity may be sensed continuously or sequentially from one garment zone to another. This embodiment is implemented by selectively positioning and weaving the various fibers of the garment and then converting a desired input pattern to a textile-generated and electrically stimulated sensation in conjunction with the woven fibers.

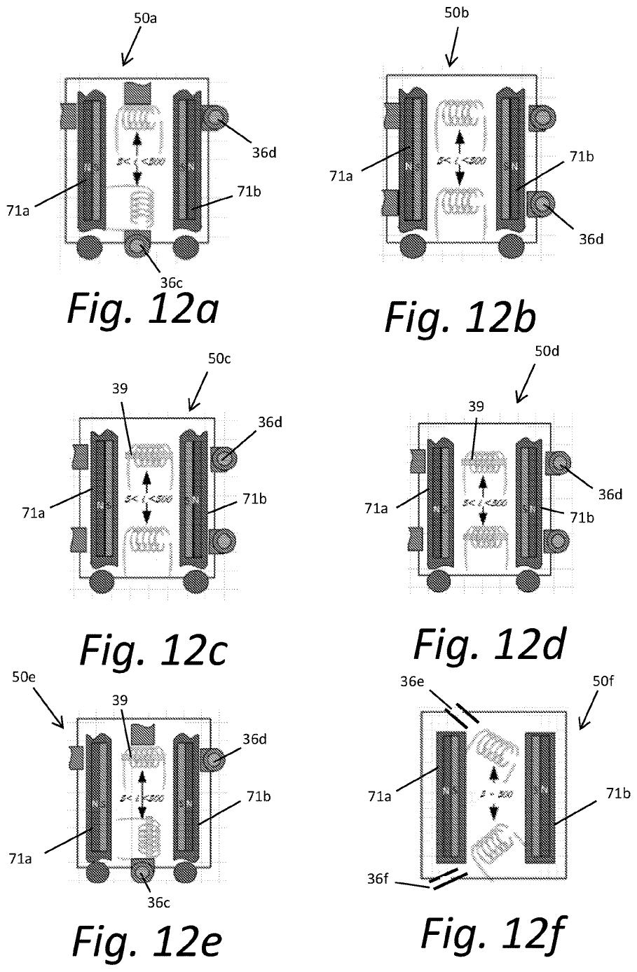

FIGS. 12a-f schematically illustrate six weaves, respectively, of selectively positioned coiled fibers used for producing a textile-generated and electrically stimulated sensation, wherein a pair of coils are separated by a distance ranging from 5-500 mm for example. Each of the illustrated weaves comprises a pair of magnetic fibers 71a-b separated by a distance ranging from 0.5-5 mm for example, and each magnetic fiber comprises a single permanent magnet extending throughout its length. Magnetic fiber 71a is identical to magnetic fiber 71b but having a permanent magnet of opposite polarity.

Weave 50a shown in FIG. 12a includes a vertically oriented conductive wire 36c around which is wound a coil, a horizontally oriented conductive wire 36d around which is wound a coil. Conductive wires 36c and 36d are provided without a ferromagnetic filling.

Weave 50b shown in FIG. 12b includes two horizontally oriented conductive wires 36d around which is wound a corresponding coil. Conductive wires 36d are provided without a ferromagnetic filling.

Weave 50c shown in FIG. 12c includes two horizontally oriented conductive wires 36d around which is wound a corresponding coil, one of which is provided with a ferromagnetic filling 39 and the other is provided without a ferromagnetic filling.

Weave 50d shown in FIG. 12d includes two horizontally oriented conductive wires 36d around which is wound a corresponding coil, both of which being provided with a ferromagnetic filling 39.

Weave 50e shown in FIG. 12e includes vertically oriented coiled conductive wire 36c and horizontally oriented coiled conductive wire 36d, both of which being provided with a ferromagnetic filling 39.

Weave 50f shown in FIG. 12f includes two obliquely oriented conductive wires 36e and 36f around which is wound a corresponding coil. Conductive wires 36e and 36f are provided without a ferromagnetic filling, but it will be appreciated that one or both may be provided with a ferromagnetic filling.

Although weaves 50a-f are shown to comprise a single coil wound about a conductive wire, it will be appreciated that a plurality of longitudinally spaced coils may be wound about the same conductive wire or positioned within the lumen of the same conductive wire.

It is envisioned that other weaves may be provided that incorporate other active components, such as the capsules shown in FIG. 15, in addition to or in place of the illustrated magnetic fiber or any of the illustrated coiled fibers.

Although weaves 50a-f are shown to be two-dimensional, it will be appreciated that each weave generally has a characteristic depth so as to be three-dimensional.

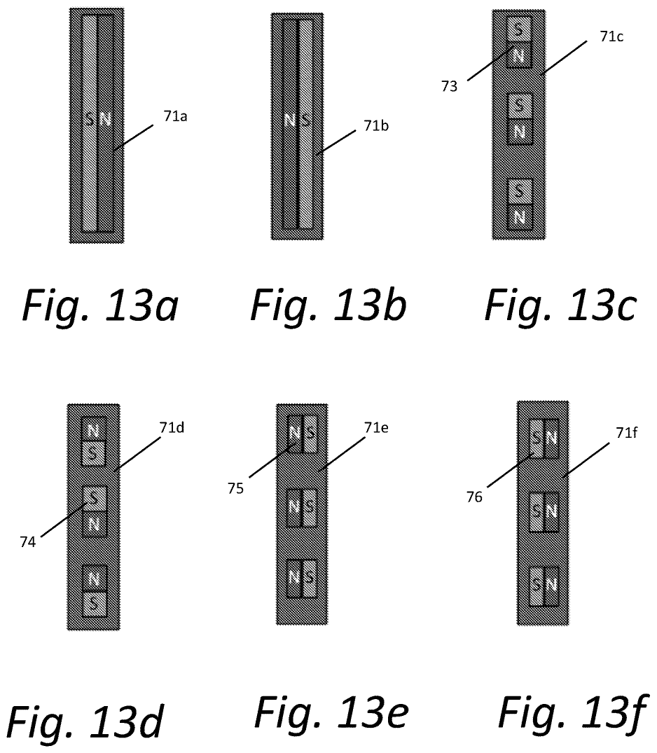

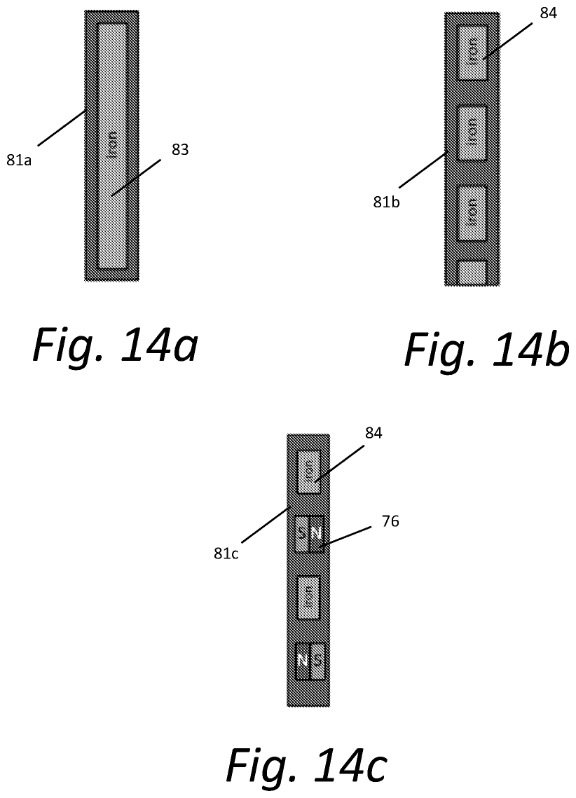

Any of the magnetic fibers 71a-f schematically illustrated in FIGS. 13a-f, respectively, or the ferromagnetic fibers 81a-c schematically illustrated in FIGS. 14a-c, respectively, may be included in any of the weaves 50a-f in addition to or in place of the illustrated magnetic fiber. Magnetic fibers 71c-f comprise a plurality of permanent magnet segments that are longitudinally spaced, i.e. spaced along the length of the fiber. Segments 73 and 74, which are longitudinally oriented, are identical to each other but have a permanent magnet of opposite polarity. Segments 75 and 76, which are transversally oriented, are identical to each other but have a permanent magnet of opposite polarity. Ferromagnetic fiber 81a comprises a single ferromagnet 83 extending throughout its length. Ferromagnetic fiber 81b comprises a plurality of longitudinally spaced and longitudinally oriented ferromagnet segments 84. Ferromagnetic fiber 81c comprises a plurality of longitudinally spaced ferromagnet segments 84 and permanent magnet segments 75 and 76, or alternatively 73 and 74.

The permanent magnet segments and ferromagnet segments may be fabricated by double head extrusion so that one injection head is dedicated to produce the magnet or ferromagnet segments.

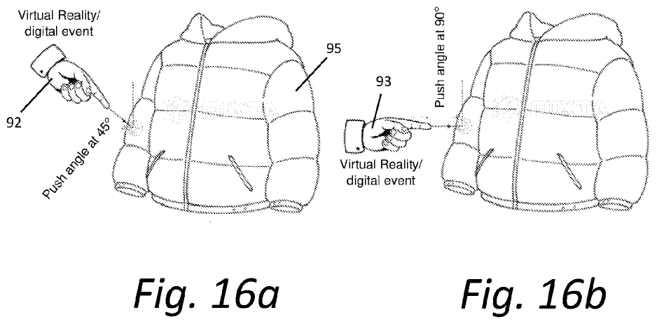

FIGS. 16a-b schematically illustrate two sensations 92 and 93, respectively, felt by a wearer of garment 95. Sensation 92 may be a localized pressing sensation felt at an angle oblique to a horizontal plane, and sensation 93 may be a pressing sensation felt at an angle parallel to a horizontal plane.

Each of sensations 92 and 93 is generated in response to one or more magnet movements caused by corresponding induced magnetic fields. The magnet movements, which may emulate a vector, are often coordinated with each other to produce a resultant movement or vector. For example, sensation 92 may be felt at an angle of 45 degrees relative to a horizontal plane when current of equal magnitude is delivered through each of coiled vertically oriented wire 36c and coiled horizontally oriented wire 36d of weave 50a shown in FIG. 12a, causing selective movement of the magnetic fibers as a result of interaction of the one or more magnets and/or ferromagnets carried by each fiber with the induced magnetic field. Likewise, the resultant vector of magnet movements will change when the current magnitude delivered through one of the wires is adjusted or the relative angle of one of the magnetic fibers is repositioned. Sensation 93 may be felt when current is delivered through coiled horizontally oriented wire 36d of weave 50a but not through coiled vertically oriented wire 36c. The sensation will be more pronounced when a ferromagnetic filling is inserted within one or both of the coiled wires, as shown in weaves 50c-e.

Composite sensations may also be generated by sequentially or simultaneously generating more than one individual sensation. Thus a same sensation or a varying sensation may be continuously, periodically or intermittently felt from one garment zone to another.

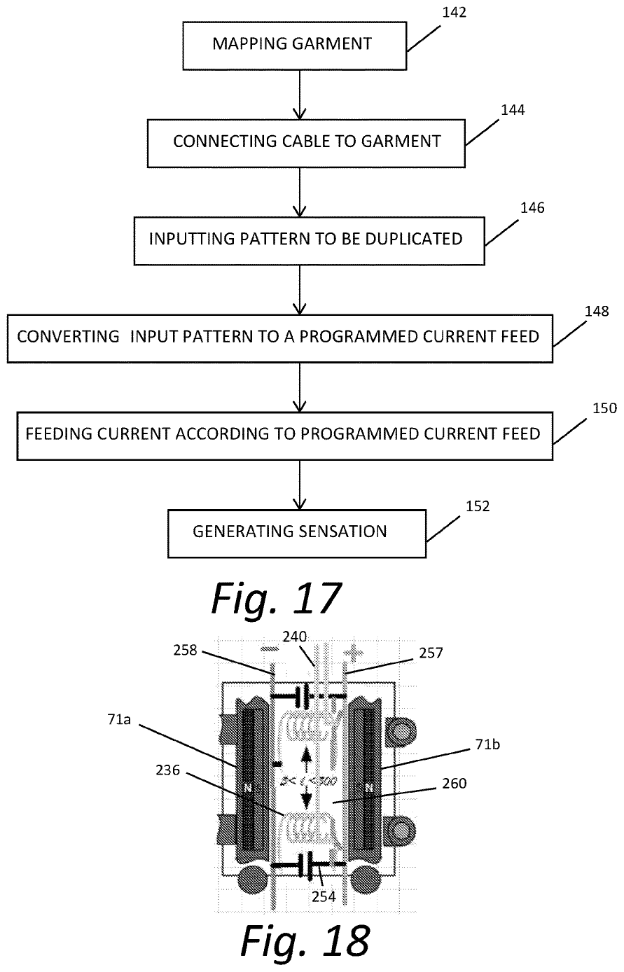

FIG. 17 illustrates a method for generating a composite or single sensation, according to one embodiment. The garment serving as the medium by which the sensation is felt is mapped for each fiber in step 142 in terms of fiber identifier, fiber type, fiber location, fiber length, fiber width, fiber orientation and inter-fiber spacing. A cable through which current is fed from the controller is connected to the garment in step 144. A pattern to be duplicated by the generated sensation is input to a screen in data communication with the controller by interfacing with a dedicated GUI in step 146, or alternatively by a digital input transmitted directly to the controller. When the screen is a touch screen, a pressure sensor may detect the pressure applied at each region of the pattern and also transmit the pressure pattern to the controller. The API converts in step 148 the input pattern to a programmed sequential or multiplexed current feed to the various conductive wires of the garment that is suitable to duplicate the desired pattern by various induced magnetic movements, for example by analyzing the pixels that are displayed on the screen. Finally, the controller feeds current through the cable according to the programmed current feed in step 150 and a corresponding textile-generated and electrically stimulated sensation is generated in step 152.

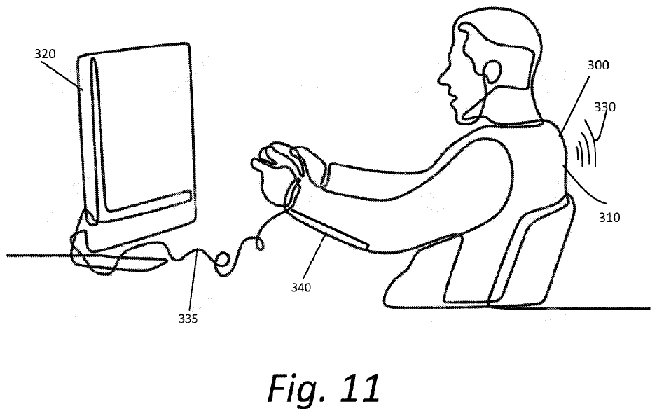

FIG. 11 illustrates one exemplary use case of the active textiles described herein. A gamer 300 is wearing a garment 310 while playing a game on system 320. During playing of the game, a scene is displayed on the display of the system 320. The system 320 generates touch movements 330 in the garment that correspond to events being displayed in the scene.

Also schematically illustrated in FIG. 11, according to one embodiment, is a flexible and individually controlled multi-contact connector 340 that is peripherally attached to garment 310 and is electrically connected to controller-connected cable 335. Each contact of connector 340 has its own address, and is used to deliver a control signal along a switching conductor, which may be printed for a reduction in space, to a corresponding coil.

As shown in FIG. 18, a one-wire switching conductor 240 connected at one end to the multi-contact connector is connected at the other end to a switching element of a corresponding coil 236. Thus when a control signal is transmitted, the energized state of the corresponding coil 236 is switched from a de-energized state to an energized state to induce the magnetic field, or vice versa.

In this embodiment, each switching conductor 240 extends through the lumen of a fiber 260 interposed between two magnetic fibers 71a and 71b. It will be appreciated that switching conductor 240 may similarly extend through the lumen of any of the conductive wires 36c-f shown in FIGS. 12a-f to be connected to a corresponding coil.

In addition to each switching conductor 240 and the corresponding coil 236, a feed capacitor 254 connected to the corresponding coil 236 and parallel-connected positive wire 257 and negative wire 258 are also positioned within the lumen of fiber 260. Feed capacitor 254 is also connected to wires 257 and 258 to be charged thereby. This arrangement reduces the number of conductors that need to be provided for each coil.

Another use case for the active textiles is in the realm of medical care. For example, rhythmic movement disorder (RMD) is a sleep disorder, common in toddlers, involving repetitive movements of large muscle groups immediately before and during sleep. In addition, the toddler typically wakes up every 45 minutes and in order to return sleeping, should receive a neural stimulation. As a result, the toddler may unwittingly bang his head (to obtain such a neural stimulation), injuring himself (otherwise, he will not be able to return sleeping again). One treatment for RMD is to perform RMD-like motions during the day in a slow and method manner, coming short of the full rhythmic movements that are experienced in sleep. Such behavioral training has been shown to carry over into sleep, and the forcefulness of the RMD movements is reduced or eliminated. In order to plan and execute this training, a head strap may be constructed for the toddler. The head strap includes a gyroscope, for measuring the toddler's inadvertent head movements; the active textiles described herein; and a controller, which may be controlled through Bluetooth communication. The controller may be programmed to induce vibrations in the active textile that correspond to the patterns of the RMD movements.

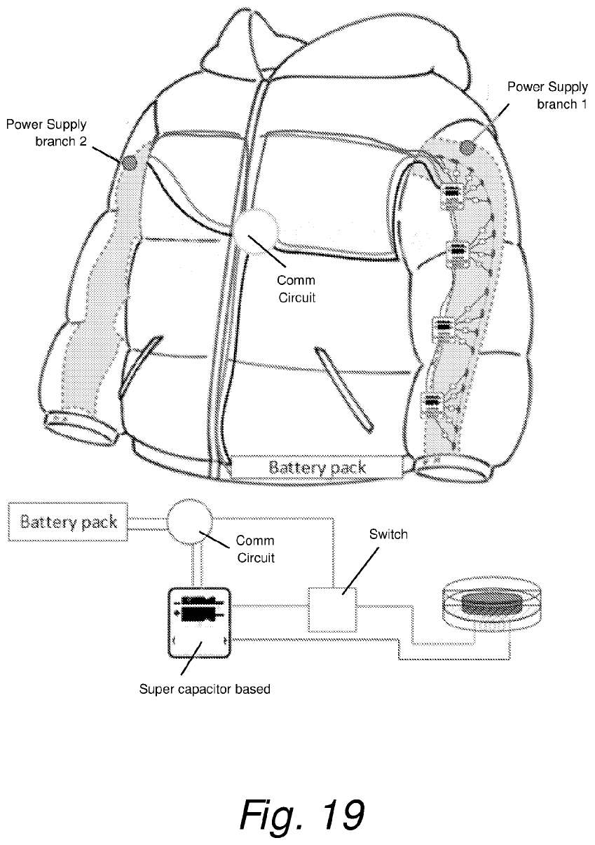

FIG. 19 illustrates an implementation of voltage supply and command to capsules and coils, according to an embodiment of the invention. In this example, power to the command circuit and a super capacitor designed to feed the capsules/coils for activation is supplied from a battery. The activation of capsules/coils is done through an electronic switch, for each individual vibration. In this mode of operation, the fabric is divided into main areas (secondary voltage supply branch) and supercapacitors are deployed in each area, to provide a feed solution for several vibrations at the same time. This way, about 30% of the copper that was supposed to be used for the purposes of feeding each vibration separately is saved.

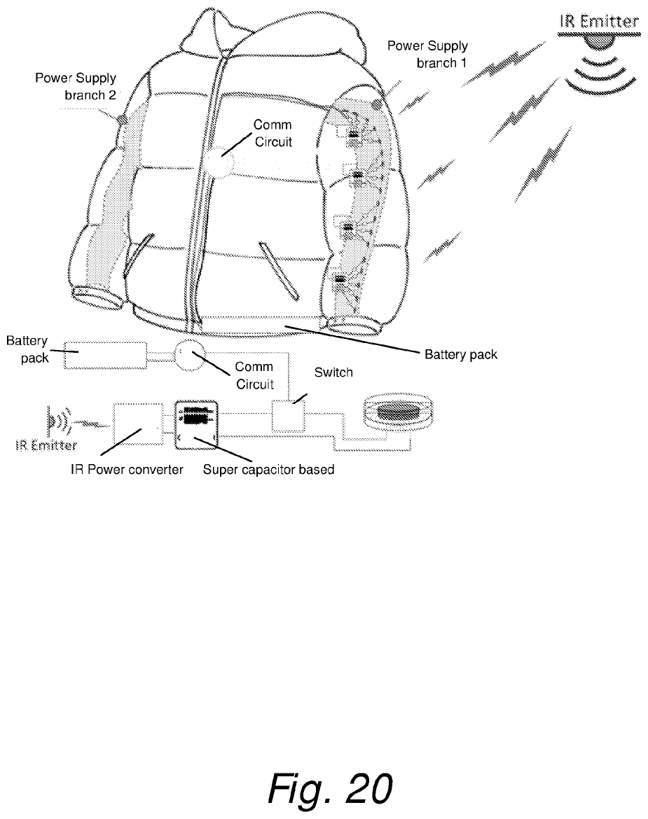

FIG. 20 illustrates another implementation of voltage supply and command to capsules and coils, according to an embodiment of the invention. In this example, power to the command circuit and a super capacitor designed to feed the capsules/coils for activation is supplied via an infrared distributor. The infrared signal is received in the fabric by a converter that converts the infrared signal power into a voltage that charges the supercapacitors, to thereby feed the capsules/coils. The activation of the capsules/coils is done through an electronic switch for each individual vibration. This way, the fabric is divided into main areas (a secondary voltage supply branch). Supercapacitors are deployed in each area to provide a feed for several vibrations at the same time. Hence, 75% of the copper that was supposed to pass through the cloth for the purposes of activating the capsules/coils, is saved.

1. An active textile, comprising:
a weave comprised of threads made of a plurality of conductive fibers; a plurality of magnets; and a plurality of non-conductive, non-magnetic flexible fabric fibers;
a controller for generating and selectively transmitting electric current along the conductive fibers;
and a power source;
wherein selective transmittal of electric current along the conductive fibers selectively induces magnetic fields that operate on the magnets, thereby producing physical movements within the textile.

2. The active textile of claim 1, wherein the induced physical movements are vibrations of varying intensities.

3. The active textile of claim 1, wherein the control circuit includes a transceiver for wirelessly receiving commands to selectively transmit the electrical pulses.

4. The active textile of claim 1, wherein each conductive fiber includes an inner conductive core and an insulating sheath surrounding the conductive core.

5. The active textile of claim 1, wherein the conductive material is configured to conduct a current of up to approximately 200 milliamps.

6. The active textile of claim 1, wherein the magnets are embedded in capsules, wherein the capsules are oriented along a length of fibers that are parallel to the conductive fibers.

7. The active textile of claim 1, wherein the plurality of conductive fibers comprise hollow conductive fibers, said hollow conductive fibers comprising an interior cavity, one or more magnets within the interior cavity, and a conductive wire coiled around the interior cavity, wherein transmittal of an electric pulse on the conductive wire generates a magnetic field within the interior cavity, causing movement within the cavity of the one or more magnets.

8. The active textile of claim 7, further comprising a ferromagnetic material within the interior cavity.

9. The active textile of claim 1, wherein the weave comprises a three-dimensional structure with a plurality of layers, wherein the conductive fibers are spaced at minimum distances from each other both horizontally, within each layer, and vertically, between different layers.

10. The active textile of claim 9, further comprising a magnetic insulator in between one or more of the layers.

11. The active textile of claim 9, wherein selective transmittal of electric current among different vertical layers creates a push-and-pull sensation along a depth of the active textile.

12. The active textile of claim 9, wherein selective transmittal of electric current along an extent of a conductive fiber within a particular layer generates a touch sensation along an extent of the active textile in a continuous vector.

13. A garment comprising the active textile of claim 1.

14. A system comprising:
the active textile of claim 1;
a display; and
a computer program product comprising software instructions that, when executed by the computer, cause (1) display of a scene on the display; and (2) issuing of instructions from the control circuit to generate physical movements of the active textile that are consistent with the scene.

15. A method of controlling movement of an active textile, comprising:
selectively transmitting electric current along conductive fibers of an active textile, wherein the active textile includes a weave comprised of threads made of a plurality of conductive fibers; a plurality of magnets; and a plurality of non-conductive, non-magnetic flexible fabric fibers; a control circuit for generating and selectively transmitting electric current along the conductive fibers; and a power source;
wherein selective transmittal of electric current along the conductive fibers selectively induces magnetic fields that operate on the magnets, thereby producing physical movements within the textile.

16. The method of claim 15, wherein the physical movements comprise vibrations of varying intensities.

17. The method of claim 15, wherein the physical movements comprise movement along the length of a fiber caused by travel of a magnet within said fiber.

18. The method of claim 15, further comprising selectively transmitting electric current among different vertical layers to thereby create a push-and-pull sensation along a depth of the active textile.

19. The method of claim 15, further comprising selectively transmitting electric current along an extent of a conductive fiber within a particular layer to thereby generate a touch sensation along an extent of the active textile in a continuous vector.

20. The method of claim 15, further comprising displaying a scene on a display, and generating physical movements of the active textile that are consistent with the scene.
